(19) United States
(12) Patent Application Publication
(10) Pub. No.: US 2025/0130663 A1
(43) Pub. Date: Apr. 24, 2025

(54) SENSOR CONTROLLER AND STYLUS

(71) Applicant: Wacom Co., Ltd., Saitama (JP)

(72) Inventors: Haruhiko HISANO, Saitama (JP); Yoshifumi KONDA, Saitama (JP); Hideyuki HARA, Saitama (JP)

(21) Appl. No.: 18/922,079

(22) Filed: Oct. 21, 2024

(30) Foreign Application Priority Data
Oct. 23, 2023 (JP) 2023-181806

(51) Int. Cl. G06F 3/041; G06F 3/0354; G06F 3/038

(52) U.S. Cl. CPC G06F 3/04162; G06F 3/03545; G06F 3/0383

(57) ABSTRACT

Provided is a sensor controller configured to transmit, in either one of a first setting and a second setting different from the first setting, an uplink signal including a predetermined preamble, and select a selected one of the first setting or the second setting and transmit the uplink signal in the selected one of the first setting or the second setting.

### BACKGROUND

### Technical Field

The present disclosure relates to a sensor controller and a stylus.

### Description of the Related Art

There is a position detection apparatus with an active capacitance system, which is configured to allow a sensor controller and a stylus to perform two-way communication through a sensor electrode group embedded in a touch surface. Hereinafter, a signal transmitted from the sensor controller to the stylus in the two-way communication will be referred to as an “uplink signal,” and a signal transmitted from the stylus to the sensor controller will be referred to as a “downlink signal.”

A specific generation method of the uplink signal is disclosed in Japanese Patent Laid-Open No. 2020-042867. As illustrated in Japanese Patent Laid-Open No. 2020-042867, the uplink signal is generated by using a predetermined spread code (spread code with autocorrelation characteristics) to spread a symbol sequence obtained by adding a predetermined preamble to the top of a command to be transmitted.

An example of a stylus is disclosed in Chinese Published application No. 112286381. The stylus is configured to adjust the frequency of the downlink signal when the received uplink signal includes an interference signal. In this way, the stylus prevents the effect of the interference signal when the sensor controller receives the downlink signal.

A position detection apparatus, such as a foldable smartphone and a tablet terminal including a sensor electrode group provided with an indium tin oxide (ITO) film with the resistance larger than the resistance of a metal film, in which a heavy load is imposed on the sensor controller, has emerged in recent years. In addition, it may be difficult for the stylus to receive the uplink signal when noise is superimposed on the uplink signal.

### BRIEF SUMMARY

Therefore, an embodiment of the present disclosure provides a sensor controller and a stylus that can reduce a load of the sensor controller and that can reduce an effect of noise when the stylus receives an uplink signal.

Further, when the sensor controller is configured to use one of two or more systems different from each other to transmit the uplink signal, the stylus waiting for only the uplink signal transmitted by another system fails to receive the uplink signal. In this case, the sensor controller cannot start communicating with the stylus, and improvement may be necessary.

Hence, another embodiment of the present disclosure provides a sensor controller that can use one of two or more systems different from each other to transmit an uplink signal and that can appropriately start communicating with a stylus.

A first aspect of the present disclosure provides a sensor controller configured to transmit, in either one of a first setting and a second setting different from each other, an uplink signal including a predetermined preamble, and select one of the first setting and the second setting and transmit the uplink signal in the selected one of the settings.

The first aspect of the present disclosure provides a stylus including a receiver configured to detect both an uplink signal transmitted in a first setting and an uplink signal transmitted in a second setting different from the first setting.

A second aspect of the present disclosure provides a sensor controller configured to use a first system to transmit a first uplink signal, determine whether a stylus has failed to detect the first uplink signal, and use a second system different from the first system to transmit a second uplink signal when the sensor controller determines that the stylus has failed to detect the first uplink signal.

According to the first aspect of the present disclosure, the sensor controller can properly use the first setting and the second setting to transmit the uplink signal. This can reduce the load of the sensor controller and reduce the effect of the noise when the stylus receives the uplink signal.

According to the second aspect of the present disclosure, the sensor controller transmits the second uplink signal when the stylus has failed to detect the first uplink signal. Thus, the sensor controller can use one of the two or more systems different from each other to transmit the uplink signal and can appropriately start communicating with the stylus.

### BRIEF DESCRIPTION OF THE SEVERAL VIEWS OF THE DRAWINGS

FIG. 1 depicts a configuration of a position detection system according to an embodiment of the present disclosure;

FIG. 2 depicts transmission and reception timing of an uplink signal and a downlink signal;

FIG. 3A depicts a configuration of the uplink signal;

FIG. 3B depicts an example of a spread code with autocorrelation characteristics;

FIG. 4 depicts an internal configuration of a stylus;

FIG. 5 depicts transition of operation modes of a micro controller unit (MCU); and

FIG. 6 is a flow chart illustrating a process executed by a sensor controller.

### DETAILED DESCRIPTION

An embodiment of the present disclosure will hereinafter be described in detail with reference to the attached drawings.

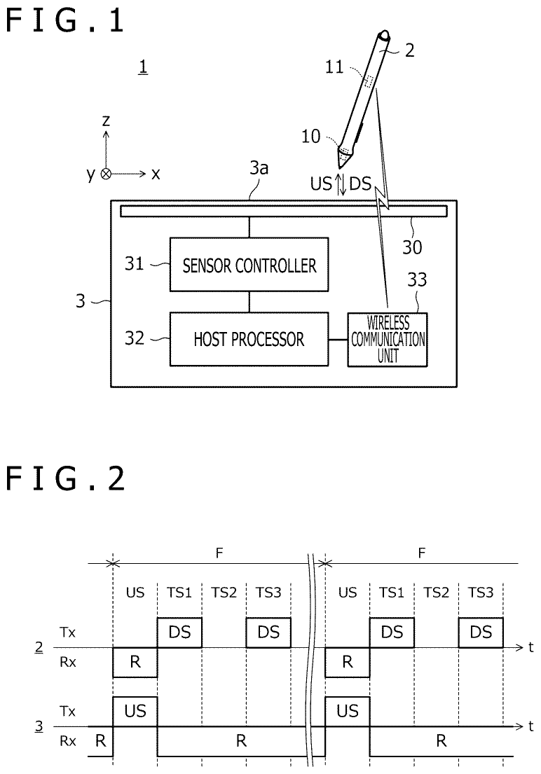

FIG. 1 depicts a configuration of a position detection system 1 according to the present embodiment. As illustrated in FIG. 1, the position detection system 1 includes a stylus 2 and a position detection apparatus 3.

The position detection apparatus 3 will be described first. The position detection apparatus 3 is a computer with a function of detecting the stylus 2. As illustrated in FIG. 1, the position detection apparatus 3 includes a panel surface 3a (touch surface), a sensor 30 arranged right below the panel surface 3a, a sensor controller 31, a host processor 32, and a wireless communication unit 33. In a typical example, the position detection apparatus 3 is a personal computer, such as a smartphone, a tablet terminal, and a laptop. The panel surface 3a may also be used as a display surface of a display, and in that case, the display is arranged on top of the sensor 30.

The sensor 30 is an apparatus used by the sensor controller 31 to communicate with the stylus 2, and the sensor 30 includes a sensor electrode group arranged in the panel surface 3a.

Specifically, the sensor electrode group includes a plurality of X electrodes extending in a y direction in the panel surface 3a and arranged side by side at equal intervals in an x direction, and a plurality of Y electrodes extending in the x direction in the panel surface 3a and arranged side by side at equal intervals in the y direction. The plurality of X electrodes and the plurality of Y electrodes are independently connected to the sensor controller 31. One of the plurality of X electrodes and the plurality of Y electrodes may also be used as common electrodes in the display, and the position detection apparatus 3 in that case is called an “in-cell type.” In contrast, the plurality of X electrodes and the plurality of Y electrodes may not be used as common electrodes in the display, and the position detection apparatus 3 in that case is called an “on-cell type” or an “out-cell type.”

In a case of arranging the sensor 30 on the upper surface of the display, the plurality of X electrodes and the plurality of Y electrodes include transparent conductors, such as ITO described above, or thin wires, such as mesh conductors, in order to secure the visibility of the display. The resistance of the X electrodes and the Y electrodes configured in this way is larger than that when the X electrodes and the Y electrodes include plate-shaped metal films, and a heavy load is imposed on the sensor controller 31. A heavy load is also imposed on the sensor controller 31 when the position detection apparatus 3 is a foldable smartphone that has emerged in recent years. An object of the present disclosure is to allow the sensor controller 31 subject to the heavy load to transmit an uplink signal with a lower speed operation and thereby reduce the load.

The sensor controller 31 is an integrated circuit including a function of communicating with the stylus 2 through the sensor 30 (first communication method) to derive a position of the stylus 2 (hereinafter, referred to as a “pen position”) in the panel surface 3a and acquire data (hereinafter, referred to as “pen data”) from the stylus 2, and a function of successively supplying reports including the derived pen positions and the acquired pen data to the host processor 32. The sensor controller 31 can include a processor that executes programs (i.e., instructions) included as hardware or programs stored in an internal memory, to realize the functions, and execute various processes described later.

The communication between the sensor controller 31 and the stylus 2 through the sensor 30 is executed by, for example, an active capacitance system. The active capacitance system is a communication system for transmitting and receiving signals through capacitive coupling between the sensor electrode group included in the sensor 30 and a pen tip electrode 10 of the stylus 2. Hereinafter, the signal transmitted by the sensor controller 31 to the stylus 2 through the sensor 30 will be referred to as an “uplink signal US,” and the signal transmitted by the stylus 2 to the sensor controller 31 through the sensor 30 will be referred to as a “downlink signal DS.”

FIG. 2 depicts transmission and reception timing of the uplink signal US and the downlink signal DS. As illustrated in FIG. 2, the sensor controller 31 is configured to communicate with the stylus 2 in units of a frame F with a predetermined time length. At the top of each frame F, the sensor controller 31 uses the plurality of X electrodes or the plurality of Y electrodes to transmit the uplink signal US. The uplink signal US transmitted in this way plays a role of notifying the stylus 2 of the temporal position of the frame F and the timing (time slot) at which the stylus 2 should transmit the downlink signals DS in the frame F. The stylus 2 detects the temporal position of the frame F from the reception timing of the uplink signal US and uses the time slots notified by the uplink signal US among the plurality of time slots included in the frame F to transmit the downlink signals DS.

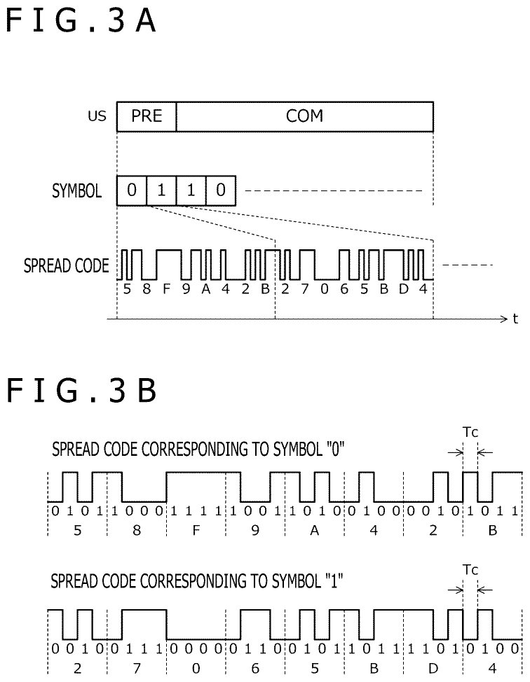

FIG. 3A depicts a configuration of the uplink signal US. As illustrated in FIG. 3A, the uplink signal US includes a preamble PRE and a command COM. The preamble PRE is a part used by the stylus 2 to detect the uplink signal US, and the preamble PRE includes a predetermined symbol sequence. Meanwhile, the command COM is a part including an instruction (command) from the sensor controller 31 to the stylus 2, and the command COM includes a symbol sequence indicating the command.

The symbol sequence includes one or more symbols. Each symbol may be information associated with “0” or “1” as illustrated in FIG. 3A, may be information associated with a bit sequence of a plurality of bits, or may be information not associated with a bit sequence (for example, information used only for indicating the position of the preamble PRE). A spread code with autocorrelation characteristics is used to transmit each symbol.

FIG. 3B depicts an example of the spread code. FIG. 3B illustrates an example of the spread code associated with symbol “0” and the spread code associated with symbol “1.” The spread code in the example includes a chip sequence (pseudo-random numbers) including 32 chips. However, the number of chips included in one spread code is not limited to 32. In the example, the spread code associated with symbol “1” is an inversion of the spread code associated with symbol “0.” In the following description, a time length Tc of each illustrated chip will be referred to as a “chip length,” and a reciprocal 1/Tc of the chip length Tc will be referred to as a “chip rate.”

The sensor controller 31 supplies a pulse signal indicating the spread codes to the sensor 30 to transmit the uplink signal US. In this case, the value of each chip is represented by the voltage of the pulse signal. However, a carrier signal (sinusoidal signal) with a predetermined frequency may be transmitted instead of the pulse signal, and in that case, the value of each chip is represented by the phase of the carrier signal.

The sensor controller 31 of the present embodiment can use any one of a plurality of settings different from each other to transmit the uplink signal US including the predetermined preamble PRE. In the settings, the chip lengths (chip rates) may be different from each other, the frequencies of the carrier signal may be different from each other, or the combinations of the chips included in the spread code associated with each symbol (that is, the type of spread code) may be different from each other. The larger the chip length (that is, the smaller the chip rate), the smaller the load of the sensor controller 31 regarding the transmission of the uplink signal US. The lower the frequency of the carrier signal, the smaller the load. The shorter the spread code, the smaller the load. The number of settings of the uplink signal US may be two or may be three or more. An example of using a first setting and a second setting with chip lengths different from each other will be illustrated below to continue the description.

The sensor controller 31 is configured to select one of the first setting and the second setting and use the selected setting to transmit the uplink signal US. The sensor controller 31 is configured to determine whether the stylus 2 has failed to detect the transmitted uplink signal US. The sensor controller 31 is configured to use the other setting to transmit the uplink signal US, when the sensor controller 31 determines that the detection has failed. The setting may be selected according to a result of communication with the stylus 2 carried out by use of near field communication (second communication method) described later or may be selected according to a response from the stylus 2 (contents of the downlink signal DS) regarding the transmitted uplink signal US. The details of these will be described in more detail again later with reference to a flow chart illustrating the process of the sensor controller 31.

FIG. 2 will be described again. The downlink signal DS may include a position signal for the sensor controller 31 to detect the pen position and a data signal modulated by the pen data to be transmitted to the sensor controller 31. The sensor controller 31 uses the plurality of X electrodes and the plurality of Y electrodes included in the sensor 30 to receive the position signal. The sensor controller 31 uses a normal distribution curve to approximate the distribution of the reception strength of the position signal in the x direction and the y direction and derives each peak position to thereby derive the pen position. The sensor controller 31 uses one X electrode or Y electrode closest to the most recently derived pen position to receive the data signal. The sensor controller 31 demodulates the data signal to acquire the pen data transmitted by the stylus 2. The pen data acquired in this way may include a response to the command in the uplink signal US as well as a pen pressure value indicating the pressure applied to the pen tip of the stylus 2 and switch information indicating the on-off state of a switch provided on the surface of the stylus 2.

FIG. 1 will be described again. The host processor 32 is a central processing unit of the position detection apparatus 3 with a function of controlling the components of the position detection apparatus 3. The host processor 32 can execute programs stored in an internal memory, to execute an operating system of the position detection apparatus 3 and various applications including a drawing application.

The series of reports supplied by the sensor controller 31 to the host processor 32 are used by the host processor 32 for the processes executed by the operating system and the drawing application. The processes include generating and displaying digital ink, moving a cursor, and detecting various gestures, such as tap and drag.

The wireless communication unit 33 is an apparatus that uses near field communication, such as Bluetooth (registered trademark), to communicate with other apparatuses including the stylus 2. The host processor 32 can use the near field communication to communicate with the stylus 2 through the wireless communication unit 33.

The stylus 2 will be described. The stylus 2 is a pen-shaped apparatus, and as illustrated in FIG. 1, the stylus 2 includes the pen tip electrode 10 and a wireless communication unit 11. The pen tip electrode 10 is an electrode used to receive the uplink signal US and transmit the downlink signal DS through capacitive coupling of the X electrodes and the Y electrodes in the sensor 30. The wireless communication unit 11 is an apparatus that uses near field communication, such as Bluetooth (registered trademark), to communicate with other apparatuses including the position detection apparatus 3. The stylus 2 can use the near field communication to communicate with the position detection apparatus 3 through the wireless communication unit 11.

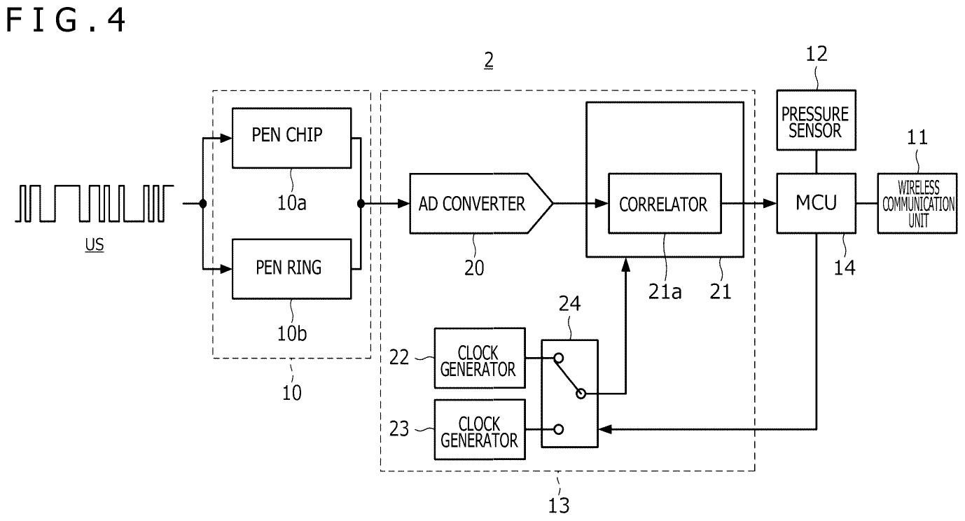

FIG. 4 depicts an internal configuration of the stylus 2. As illustrated in FIG. 4, the stylus 2 includes a pressure sensor 12, a communication unit 13, and an MCU 14 in addition to the pen tip electrode 10 and the wireless communication unit 11. In addition to these, the stylus 2 includes a core body included in the pen tip of the stylus 2, a battery that supplies operating power to the components in the stylus 2, a switch provided on the surface, a memory that stores identification information of the stylus 2, and the like, which are not illustrated in FIG. 4.

The pen tip electrode 10 includes a pen chip 10a and a pen ring 10b. The pen chip 10a is a rod-shaped electrode provided on the tip of the core body. Meanwhile, the pen ring 10b is a ring-shaped electrode so provided as to surround the core body. The stylus 2 is configured to use one of or both the pen chip 10a and the pen ring 10b to receive the uplink signal US and configured to transmit the downlink signal DS from each of the pen chip 10a and the pen ring 10b. The sensor controller 31 is configured to derive positions in reference to the downlink signal DS transmitted from the pen chip 10a and the downlink signal DS transmitted from the pen ring 10b. The sensor controller 31 is configured to acquire, as the pen position, the position derived in reference to the downlink signal DS transmitted from the pen chip 10a and derive the tilt (tilt angle) of the stylus 2 in reference to the two derived positions.

The pressure sensor 12 is a sensor that detects the pressure applied to the pen tip of the stylus 2. The value of the pressure detected by the pressure sensor 12 is supplied as a pen pressure value to the MCU 14. The MCU 14 determines that the stylus 2 is not in contact with the panel surface 3a (the stylus 2 is hovering) when the pen pressure value supplied from the pressure sensor 12 is a predetermined value (for example, 0). The MCU 14 determines that the stylus 2 is in contact with (in touch with) the panel surface 3a when the pen pressure value exceeds a predetermined value (for example, 0). The state in which the pen tip of the stylus 2 is in contact with the panel surface 3a will hereinafter be referred to as “pen touch.”

The communication unit 13 is a functional unit including a function of converting the uplink signal US (spread code) received by the pen tip electrode 10 into a symbol sequence and supplying the symbol sequence to the MCU 14, and a function of converting the downlink signal DS (symbol sequence) supplied from the MCU 14 into a spread code similar to the uplink signal US and supplying the spread code to the pen tip electrode 10. FIG. 4 illustrates only the function related to the uplink signal US.

The function of the communication unit 13 related to the uplink signal US will specifically be described with reference to FIG. 4. The communication unit 13 includes an analog-to-digital (AD) converter 20, a custom logic circuit 21, clock generators 22 and 23, and a switch circuit 24.

The AD converter 20 is a circuit that samples the uplink signal US supplied from the pen tip electrode 10 at a predetermined sampling rate and further quantizes and encodes the uplink signal US. The AD converter 20 converts the analog signal received as the uplink signal US into a bit sequence of “1” or “0” and supplies the bit sequence to the custom logic circuit 21. The sampling rate of the AD converter 20 is set to a value faster than the chip rate of the uplink signal US. Meanwhile, the time length per bit of the bit sequence output from the AD converter 20 is set to the same value as the chip length of the uplink signal US.

The custom logic circuit 21 is a circuit including a correlator 21a that calculates a correlation value of the input bit sequence and a predetermined bit sequence stored in advance. The correlator 21a plays a role of calculating the correlation value of the bit sequence supplied from the AD converter 20 and the predetermined bit sequence stored in advance (bit sequence indicating the spread code), to detect the spread code included in the symbol of the uplink signal US. The custom logic circuit 21 generates a symbol sequence according to the detection result of the correlator 21a and supplies the symbol sequence to the MCU 14.

The clock generator 22 is a circuit that generates a clock signal oscillating at a cycle corresponding to the chip length in the first setting. The clock generator 23 is a circuit that generates a clock signal oscillating at a cycle corresponding to the chip length in the second setting. The switch circuit 24 is a circuit that generates the clock signal generated by one of the clock generators 22 and 23 under the control of the MCU 14 and that supplies the clock signal to the custom logic circuit 21. The custom logic circuit 21 and the correlator 21a execute the processes of calculating the correlation value and generating the symbol sequence according to the clock signal supplied in this way. Hence, the cycle of the clock signal may need to coincide with the chip length of the uplink signal US in order for the symbol sequence output from the custom logic circuit 21 to properly reflect the uplink signal US.

The MCU 14 is a central processing unit of the stylus 2. The MCU 14 includes a processor that executes programs stored in a memory in order to perform a process of generating the downlink signal DS in reference to the uplink signal US received from the sensor controller 31 and transmitting the downlink signal DS to the sensor controller 31. The MCU 14 also uses near field communication to communicate with the sensor controller 31 through the wireless communication unit 11. The MCU 14 further executes a process of controlling the switch circuit 24 to switch the type (setting) of the uplink signal US that can be received.

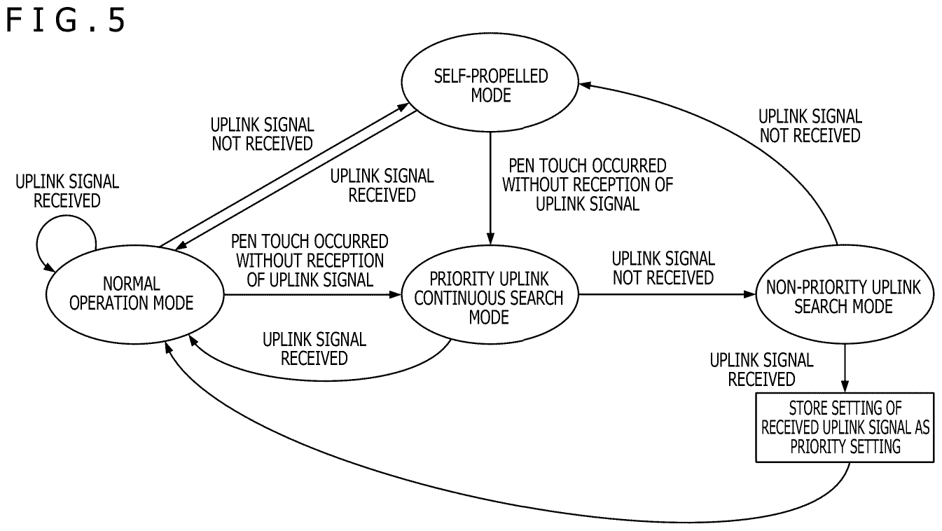

FIG. 5 depicts transition of operation modes of the MCU 14. As illustrated in FIG. 5, the MCU 14 includes four operation modes including a normal operation mode, a priority uplink continuous search mode, a non-priority uplink continuous search mode, and a self-propelled mode.

The normal operation mode is a mode for detecting the uplink signal US in reference to the symbol sequence supplied from the custom logic circuit 21 and generating and transmitting the downlink signal DS according to the detected uplink signal US. When the MCU 14 has not detected the uplink signal US yet, the MCU 14 may continuously perform the detection operation of the uplink signal US. However, it is preferable that the MCU 14 intermittently (that is, every predetermined time) execute the detection operation of the uplink signal US to reduce the consumption of the battery.

Here, the sensor controller 31 according to the present embodiment uses one of the first setting and the second setting with chip lengths different from each other to transmit the uplink signal US as described above. The MCU 14 stores in advance one of the settings as a “priority setting.” When the MCU 14 operates in the normal operation mode, the MCU 14 controls the switch circuit 24 to supply the custom logic circuit 21 with the clock signal oscillating at the cycle corresponding to the priority setting. As a result, the custom logic circuit 21 is able to properly convert the uplink signal US (hereinafter, referred to as a “priority uplink signal US”) transmitted in the priority setting into the symbol sequence, but is unable to properly convert the uplink signal US (hereinafter, referred to as a “non-priority uplink signal US”) transmitted in the setting that is not the priority setting (hereinafter, referred to as a “non-priority setting”) into the symbol sequence. Thus, the MCU 14 operating in the normal operation mode is able to detect the priority uplink signal US in reference to the symbol sequence supplied from the custom logic circuit 21, but is unable to detect the non-priority uplink signal US.

The setting stored as the “priority setting” in the MCU 14 is determined in advance.

However, the MCU 14 can use the near field communication performed through the wireless communication unit 11, to share the setting of the uplink signal US with the sensor controller 31 at a desired timing. When the MCU 14 shares the setting of the uplink signal US with the sensor controller 31, the MCU 14 stores the shared setting as the “priority setting.”

When the MCU 14 detects the uplink signal US during the operation in the normal operation mode, the MCU 14 continues the operation in the normal operation mode. The MCU 14 transmits the downlink signal DS corresponding to the detected uplink signal US and detects the next uplink signal US. In contrast, when the MCU 14 detects the occurrence of pen touch in reference to the pen pressure value supplied from the pressure sensor 12 without detecting the uplink signal US, the MCU 14 enters the priority uplink continuous search mode. The priority uplink continuous search operation mode is a mode for immediately executing the detection operation of the priority uplink signal US in response to the detection of the pen touch, and the mode is used to promptly detect the uplink signal US when, for example, the uplink signal US is not detected due to the detection interval of the uplink signal US even though the panel surface 3a is touched. When the MCU 14 detects the uplink signal US during the operation in the priority uplink continuous search mode, the MCU 14 returns to the normal operation mode. The MCU 14 transmits the downlink signal DS corresponding to the detected uplink signal US and detects the next uplink signal US.

When the MCU 14 does not detect the uplink signal US after performing the detection operation of the priority uplink signal US for a predetermined time in the priority uplink continuous search mode, the MCU 14 enters the non-priority uplink search mode. The non-priority uplink search mode is a mode for attempting to detect the non-priority uplink signal US. The MCU 14 entering the non-priority uplink search mode controls the switch circuit 24 to supply the custom logic circuit 21 with the clock signal oscillating at the cycle corresponding to the non-priority setting. In this way, the MCU 14 can detect the non-priority uplink signal US in reference to the symbol sequence supplied from the custom logic circuit 21. Note that, when there are three or more settings of the uplink signal US, the MCU 14 may sequentially attempt the settings other than the priority setting in the non-priority uplink search mode.

The MCU 14 that has detected the uplink signal US in the non-priority uplink search mode overwrites the priority setting with the setting at that point and returns to the normal operation mode. Subsequently, the non-priority setting at that point is used as the priority setting. In contrast, the MCU 14 that has not detected the uplink signal US even in the non-priority uplink search mode enters the self-propelled mode. The self-propelled mode is a mode in which the stylus 2 not receiving the uplink signal US autonomously transmits the downlink signal DS. The MCU 14 entering the self-propelled mode controls the switch circuit 24 to supply the custom logic circuit 21 with the clock signal oscillating at the cycle corresponding to the priority setting. The MCU 14 detects the priority uplink signal US and transmits the downlink signal DS in a cyclic manner. The downlink signal DS transmitted in the self-propelled mode is a special downlink signal DS including flag information indicating that the MCU 14 is in the self-propelled mode.

When the MCU 14 detects the uplink signal US in the self-propelled mode, the MCU 14 enters the normal operation mode. The process executed by the MCU 14 in the normal operation mode is as described above. The downlink signal DS transmitted by the MCU 14 in the normal operation mode does not include the flag information. When the MCU 14 detects the occurrence of pen touch in reference to the pen pressure value supplied from the pressure sensor 12 without detecting the uplink signal US in the self-propelled mode, the MCU 14 enters the priority uplink continuous search mode. The process executed by the MCU 14 in the priority uplink continuous search mode is as described above.

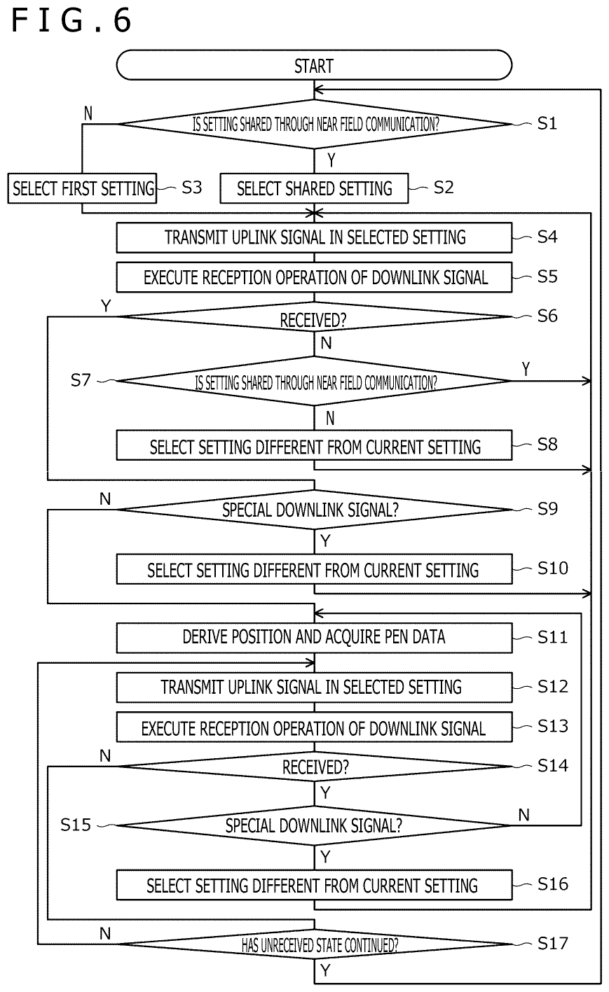

FIG. 6 is a flow chart illustrating a process executed by the sensor controller 31. The process executed by the sensor controller 31 according to the present embodiment will be described in detail with reference to FIG. 6.

The sensor controller 31 first determines whether the setting is shared through the near field communication (S1). If the sensor controller 31 determines that the setting is shared in the determination, the sensor controller 31 selects the shared setting (S2). If the sensor controller 31 determines that the setting is not shared, the sensor controller 31 selects the setting (the first setting here) determined in advance (S3).

Next, the sensor controller 31 transmits the uplink signal US in the selected setting (S4) and performs the reception operation of the downlink signal DS (S5). The sensor controller 31 determines whether the downlink signal DS is received as a result of the reception operation (S6). If the sensor controller 31 determines that the downlink signal DS is not received, the sensor controller 31 determines again whether the setting is shared through the near field communication (S7). As a result, if the sensor controller 31 determines that the setting is shared, the sensor controller 31 immediately returns to S4. If the sensor controller 31 determines that the setting is not shared, the sensor controller 31 selects the setting different from the current setting (S8) and returns to S4. In this way, the sensor controller 31 continues to transmit the uplink signal US in the shared setting when the setting is shared through the near field communication, until the downlink signal DS is received. The sensor controller 31 continues to alternately transmit the uplink signal US in the first setting and transmit the uplink signal US in the second setting when the setting is not shared through the near field communication.

If the sensor controller 31 determines that the downlink signal DS is received at S6, the sensor controller 31 determines whether the received downlink signal DS is the “special downlink signal DS” (S9). As a result, if the sensor controller 31 determines that the received downlink signal DS is the “special downlink signal DS,” the sensor controller 31 selects the setting different from the current setting (S10) and returns to S4. The determination that the received downlink signal DS is the “special downlink signal DS” at S9 signifies that the stylus 2 has failed to detect the transmitted uplink signal US and the stylus 2 has entered the self-propelled mode. The execution of S9 and S10 can increase the possibility that the stylus 2 can receive the uplink signal US again.

The sensor controller 31 that has determined that the received downlink signal DS is not the “special downlink signal DS” at S9 derives the position of the stylus 2 in reference to the received downlink signal DS and acquires the pen data transmitted by the stylus 2 (S11). The sensor controller 31 outputs the pen data to the host processor 32. The sensor controller 31 then transmits the uplink signal US again in the selected setting (S12) and performs the reception operation of the downlink signal DS (S13).

Next, the sensor controller 31 determines whether the downlink signal DS is received (S14). As a result, if the sensor controller 31 determines that the downlink signal DS is received, the sensor controller 31 determines whether the received downlink signal DS is the “special downlink signal DS” (S15). As a result, if the sensor controller 31 determines that the received downlink signal DS is the “special downlink signal DS,” the sensor controller 31 selects the setting different from the current setting (S16) and returns the process to S4. The determination that the received downlink signal DS is the “special downlink signal DS” at S15 signifies that the stylus 2 that has once normally detected the uplink signal US has started to fail to detect the uplink signal US and the stylus 2 has entered the self-propelled mode. The process of S15 and S16 can increase the possibility that the stylus 2 in such a state can return to the normal operation mode. If the sensor controller 31 determines that the received downlink signal DS is not the “special downlink signal DS” at S15, the sensor controller 31 returns to S11 and continues the process.

If the sensor controller 31 determines that the downlink signal DS is not received at S14, the sensor controller 31 determines whether the unreceived state of the downlink signal DS has continued for a predetermined number of times (or for a predetermined length of time) (S17). As a result, if the sensor controller 31 determines that the unreceived state has not continued, the sensor controller 31 returns to S12 and continues the process. If the sensor controller 31 determines that the unreceived state has continued, the sensor controller 31 returns the process to S1.

As described above, according to the position detection system 1 of the present embodiment, the sensor controller 31 can properly use the first setting and the second setting with chip lengths (chip rates) or the like different from each other to transmit the uplink signal US. Thus, the sensor controller 31 can select a low-speed operation if the low-speed operation is selectable. This can reduce the load of the sensor controller 31.

Noise is superimposed on the uplink signal US in some cases, and this may obstruct the reception of the uplink signal US in the stylus 2. However, according to the position detection system 1 of the present embodiment, the sensor controller 31 can properly use the first setting and the second setting with chip lengths (chip rates) or the like different from each other to transmit the uplink signal US. This can also reduce the effect of the noise when the stylus 2 receives the uplink signal US.

According to the position detection system 1 of the present embodiment, when the stylus 2 has failed to detect the uplink signal US transmitted in the first setting, the sensor controller 31 can detect that and transmit the uplink signal US in the second setting. Thus, the sensor controller 31 can use one of two or more settings different from each other to transmit the uplink signal US and appropriately start communicating with the stylus 2.

While an advantageous embodiment of the present disclosure has been described, the present disclosure is not limited to the embodiment in any way, and it is obvious that the present disclosure can be carried out in various modes without departing from the scope of the present disclosure.

For example, although the near field communication without the capacitive coupling to the pen tip electrode 10 is used to share the setting of the uplink signal US between the sensor controller 31 and the stylus 2 in the example described in the embodiment, an electrode other than the sensor electrode group included in the sensor 30 may be provided in the position detection apparatus 3, and the setting of the uplink signal US may be shared between the sensor controller 31 and the stylus 2 through the capacitive coupling of the electrode and the pen tip electrode 10. Examples of the electrode include a sensor electrode included in a touch pad provided on a laptop and an electrode provided in a garage for storing the stylus 2.

While the stylus 2 enters the non-priority uplink search mode to attempt to receive the non-priority uplink signal US when the stylus 2 cannot receive the priority uplink signal US in the normal mode and the priority uplink continuous search mode in the example described in the embodiment, the stylus 2 may alternately perform the reception operation of the priority uplink signal US and the reception operation of the non-priority uplink signal US when, for example, the stylus 2 has not detected the uplink signal US yet.

While the sensor controller 31 uses one of two or more settings different from each other to transmit the uplink signal US in the example described in the embodiment, the sensor controller 31 may transmit two or more different uplink signals US in a higher level. For example, the sensor controller 31 may use a version of the active capacitance system to transmit one of the uplink signals US and use a different version of the active capacitance system to transmit the other uplink signal US. The sensor controller 31 may use the active capacitance system to transmit one of the uplink signals US and use another communication method, such as near field communication and electromagnetic resonance system, to transmit the other uplink signal US. Assuming that both the case of transmitting two or more uplink signals US with settings different from each other and the case of transmitting two or more different uplink signals US in the level higher than the settings are “transmission of the uplink signal US with use of two or more systems different from each other,” the “setting” can be replaced with the “system” in the embodiment to obtain effects similar to the effects of the embodiment through similar processing.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A sensor controller comprising:
a processor; and
a memory storing instructions that, when executed by the processor, cause the sensor controller to:
transmit, in either one of a first setting and a second setting different from the first setting, an uplink signal including a predetermined preamble; and
select a selected one of the first setting or the second setting and transmit the uplink signal in the selected one of the first setting or the second setting.

2. The sensor controller according to claim 1, wherein
the first setting is a setting with a relatively large chip rate of a spread code included in the uplink signal, and
the second setting is a setting with a relatively small chip rate of the spread code included in the uplink signal.

3. The sensor controller according to claim 1, wherein
the instructions, when executed by the processor, cause the sensor controller to select the selected one of the first setting or the second setting according to a response from a stylus regarding the uplink signal that is transmitted.

4. The sensor controller according to claim 1, wherein
the instructions, when executed by the processor, cause the sensor controller to alternately transmit the uplink signal in the first setting and transmit the uplink signal in the second setting.

5. The sensor controller according to claim 1, wherein
the instructions, when executed by the processor, cause the sensor controller to select one of the first setting and the second setting according to a result of communication with a stylus executed by use of a second communication method different from a first communication method used to transmit the uplink signal.

6. The sensor controller according to claim 5, wherein
the first communication method is a communication method performed through capacitive coupling of a sensor electrode group arranged in a touch surface and a pen tip electrode of the stylus, and
the second communication method is a communication method without the capacitive coupling.

7. The sensor controller according to claim 5, wherein
the first communication method is a communication method performed through capacitive coupling of a sensor electrode group arranged in a touch surface and a pen tip electrode of the stylus, and
the second communication method is a communication method performed through capacitive coupling of an electrode different from the sensor electrode group and the pen tip electrode.

8. A stylus comprising:
a processor; and
a receiver coupled to the processor, wherein the receiver, in operation, detects both an uplink signal transmitted in a first setting and an uplink signal transmitted in a second setting different from the first setting.

9. The stylus according to claim 8, wherein
the receiver, in operation, alternately performs a reception operation of the uplink signal transmitted in the first setting and a reception operation of the uplink signal transmitted in the second setting.

10. The stylus according to claim 8, wherein
the receiver, in operation, selects the selected one of the first setting or the second setting according to a result of communication with a sensor controller performed by use of a second communication method different from a first communication method used to transmit the uplink signal, and performs a reception operation of the uplink signal transmitted in the selected one of the first setting or the second setting.

11. The stylus according to claim 10, wherein
the first communication method is a communication method performed through capacitive coupling of a sensor electrode group that is arranged in a touch surface and that is connected to the sensor controller and a pen tip electrode of the stylus, and
the second communication method is a communication method without the capacitive coupling.

12. The stylus according to claim 10, wherein
the first communication method is a communication method performed through capacitive coupling of a sensor electrode group that is arranged in a touch surface and that is connected to the sensor controller and a pen tip electrode of the stylus, and
the second communication method is a communication method performed through capacitive coupling of an electrode different from the sensor electrode group and the pen tip electrode.

13. A sensor controller comprising:
a processor; and
a memory storing instructions that, when executed by the processor, cause the sensor controller to:
use a first system to transmit a first uplink signal;
determine whether a stylus has failed to detect the first uplink signal; and
use a second system different from the first system to transmit a second uplink signal when the sensor controller determines that the stylus has failed to detect the first uplink signal.

14. The sensor controller according to claim 13, wherein
the instructions, when executed by the processor, cause the sensor controller to determine that the stylus has failed to detect the first uplink signal when the sensor controller receives a special downlink signal after transmitting the first uplink signal.

15. The sensor controller according to claim 14, wherein
the special downlink signal is a signal including information indicating that the stylus is in a self-propelled mode.

16. The sensor controller according to claim 13, wherein
the first system and the second system are systems with different frequencies of the uplink signals or different chip lengths of spread codes included in the first uplink signal and the second uplink signal.

17. The sensor controller according to claim 13, wherein
the first system and the second system are systems with different types or chip lengths of spread codes included in the first uplink signal and the second uplink signal.

18. The sensor controller according to claim 13, wherein
the first system and the second system are systems with different electrodes used for transmitting the first uplink signal and the second uplink signal.
